(19) United States
(12) Patent Application Publication
(10) Pub. No.: US 2019/0052109 A1
(43) Pub. Date: Feb. 14, 2019

(54) COUPLING SYSTEM AND APPARATUS FOR PARALLEL INTERCONNECTION OF INDEPENDENT BATTERY MODULES

(71) Applicant: Lucas Sturnfield, Downers Grove, IL (US)

(72) Inventor: Lucas Sturnfield, Downers Grove, IL (US)

(21) Appl. No.: 15/675,976

(22) Filed: Aug. 14, 2017

(51) Int. Cl. H02J 7/00; H02J 7/34

(52) U.S. Cl. CPC H02J 7/0075; H02J 7/0014; H02J 7/34

(57) ABSTRACT

A method and system is disclosed for maintaining a synchronized state of charge of a plurality of independent parallel interconnected battery packs. The system is modular and scalar and relies on an embedded BMS in each battery pack for operation, thus eliminating the need for an external BMS. Three circuits are provided in each battery pack which include a monitoring circuit, a protection circuit and a signaling circuit. The signaling circuit includes a shared status line connected to all interconnected battery packs that is monitored by each embedded BMS by way of a monitoring circuit When an initiating battery pack encounters a condition to that forces the battery pack off line, the BMS of each interconnected battery pack will activate the switches associated with its protection circuit and simultaneously signal this status to the other interconnected battery packs by way of a shared status line. When the monitoring circuits of the other interconnected battery packs sense that the low shared status line, their respective BMS generates a trip to activate its respective protection circuit to take the battery pack off line. When the issue with the initiating battery pack is resolved, the initiating battery pack will release its protection circuit and allow its battery pack to come back on line. The BMS will simultaneously generate a low Alert signal to release the shared status line. The monitoring circuits of the interconnected battery packs will sense this transition and cause their respective BMS to generate a signal releasing their protection circuits and allow the batteries to come back online.

### BACKGROUND OF THE INVENTION

### 1. Field of the Invention

The present invention relates to a system and method for maintaining a synchronized state of charge of a plurality of parallel interconnected independent battery packs.

### 2. Description of the Prior Art

Parallel connected battery packs are known to provide power to loads with relatively high amp-hour requirements. It is important with parallel connected batteries that the charge of each of the batteries be the same. Otherwise, the charge imbalance will result in batteries with high charge levels having a higher voltage than batteries with low charge levels. This voltage difference will cause extremely large surges of energy to flow from the batteries at high charge levels to the batteries with low charge levels. Thus, it is important that the batteries be balanced before being connected in parallel.

Known lithium battery packs include an integrated protection circuit. The protection circuit provides protection of the cells within the battery pack against certain anomalies, such as over-current, over-voltage and over-temperature. When multiple lithium ion battery packs are connected in parallel, an anomaly in one of the battery packs normally results in that battery pack being taken off-line, i.e. interrupting its power flow path, by its protection circuit. When initially balanced batteries are connected in parallel, the disruption of energy flow from a battery that is off-line will result in an imbalance with all the other parallel connected batteries, as the other parallel connected batteries continue their energy flow. This imbalance worsens in time as the other parallel connected batteries continue to flow energy while the off-line pack does not flow energy.

In such a situation, it is necessary to prevent the off-line battery pack from coming back on line since it will not be balanced with the rest of batteries connected in parallel. To ensure charge balance, the off-line battery pack should not be allowed to come back on-line until the other parallel connected batteries are either charged or discharged to the charge level of the off-line battery.

Various methods are known for equalizing the charge among battery cells connected in parallel. For example, Korean patent KR101634012 B1 discloses a method for balancing the charge in a plurality of parallel interconnected batteries. Upon an event that causes the charge in one or more parallel interconnected batteries to be depleted and therefore unbalanced relative to the other batteries, the disclosed charge balance methodology is based upon leaving all batteries connected and allowing the batteries with higher charge levels to equalize the charge of batteries with lower charge levels.

There are several problems associated with the system disclosed in the Korean patent. One problem relates to the fact that the battery cell initiating the event is not taken off-line to preserve the charge levels of the other parallel interconnected batteries. Another problem is that the charge control of the batteries is under the control of a separate battery management system (BMS) controller that is external to the battery packs. Such external controllers are expensive and add to the complexity of the system. Battery management systems that utilize external controllers are generally not modular and are not generally scalable which requires the need for customized battery charge control systems.

Other systems are known which utilize BMS that are external to a modular battery solution. For example, Valence Technology, Inc (www.valence.com) provides BMS that are configured for external use. (see www.valence.com/products/standard-modules/xp-module/). Also, U.S. Pat. No. 8,324,868 illustrates an application in which battery charge control is under the control of an external BMS.

Thus, there is a need for a control system capable of solving problems associated with the charge control of a plurality of parallel interconnected battery packs which can synchronize the charge levels of all interconnected battery packs without the need for an external battery management system controller and thereby provide a modular and scalable solution.

### SUMMARY OF THE INVENTION

Briefly, the present invention relates to a method and system for maintaining a synchronized state of charge of a plurality of independent parallel interconnected battery packs. The novel system is modular and scalar and relies on an embedded BMS in each battery pack for operation, thus eliminating the need for an external BMS. The embedded BMS has dual functions. One function is to work in conjunction with known battery pack protection systems for providing various safety functions, such as, over-current, over-voltage and over-temperature protection. The other function of the BMS relates to maintaining a synchronized charge among the interconnected battery packs.

Three circuits are provided within each battery pack, including a monitoring circuit, a protection circuit and a signaling circuit. The signaling circuit includes a shared status line connected to all interconnected paralleled battery packs. The shared status line is connected to a Monitor input port on the BMS, and is pulled-up to a high-logic voltage level (such as 3.3V) through a resistor. The monitoring circuit alerts the embedded BMS of changes in the logic level of the shared status line. When a change in the logic level of the shared status signal is sensed by the BMS, representing that a safety condition has been encountered, such as over-voltage, over-current, or over-temperature or the battery pack has been taken off-line manually, the battery is taken off-line by the protection circuit under the control of the BMS. The BMS simultaneously generates a high Alert signal at its output port. The logic level of the Alert signal is provided as an input to a signal circuit which is capable of changing the state of a status signal shared by all interconnected battery packs. The monitoring circuit within each battery pack senses the change of the shared status signal, informing the embedded BMS to trip its protection circuit and similarly take each parallel connected battery pack offline. When the issue with the initiating battery pack is resolved, the embedded BMS of the initiating battery pack releases its respective protection circuit allowing its battery pack to come back on-line and simultaneously resets the Alert signal which allows the shared status signal to return to a high-logic level. The monitoring circuits of the interconnected battery packs sense the restored logic state of the shared status line, and their embedded BMS releases their respective protection circuits to allow each interconnected battery packs to come back online. This method of control allows energy flow to remain synchronized between all parallel interconnected battery packs, without the need for an external “master” BMS. Further, this method of control allows each individual battery to remain entirely functional both parallel and single applications, without the need for any hardware or firmware adjustments to the individual battery, nor any other customization.

### DESCRIPTION OF THE DRAWING

These and other advantages of the present invention will be readily understood with reference to the following specification and attached drawing wherein:

FIG. 1 is block diagram illustrating a plurality of batteries connected in parallel, all connected to a common shared status line.

FIG. 2 is a block diagram of a battery pack which includes a battery module with a plurality of battery cells as well as an embedded battery management system (BMS). Also illustrated is a block diagram of protection circuit and the monitor circuit connected to a single battery pack in accordance with the invention.

FIG. 3 is a data flow diagram for the present invention.

FIG. 4 is schematic diagram of a protection, monitoring and signaling circuits in accordance with the present invention.

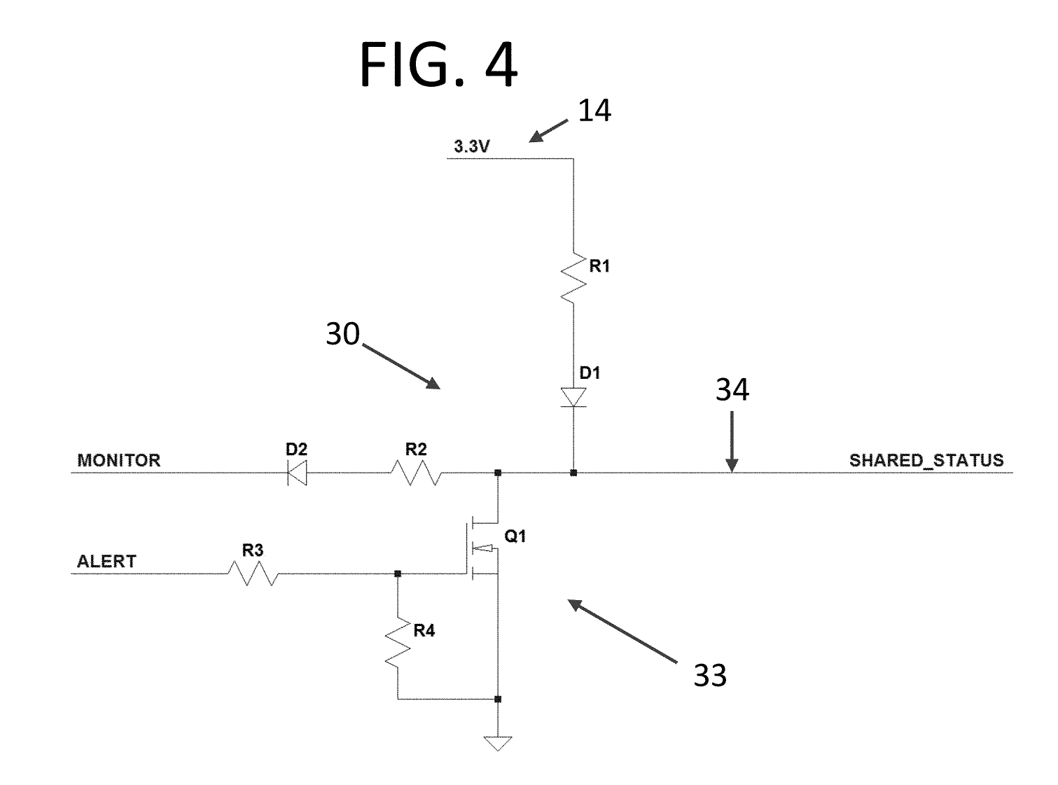

### DETAILED DESCRIPTION

The present invention relates to a method and system for maintaining a synchronized state of charge of a plurality of independent parallel interconnected battery packs. The system includes a monitoring circuit, a protection circuit and a signaling circuit that work in conjunction with an embedded Battery Management System (BMS) in each of the interconnected battery packs.

The signaling circuit may include one or more shared status lines that are connected to all parallel connected battery packs to indicate an anomaly with one of the interconnected battery packs. In lieu of a status line, the signaling circuit may be formed as a communication bus for communicating information in digital packetized form, for example, SPI, UART, I2C, CAN, Ethernet or other protocols, between battery packs or other battery systems and/or a remote server. The signaling circuit may also be formed as a series of dedicated signal lines, each intended to signal a specific status, such as over-charge, over-discharge, over-temperature, or other distinct statuses. The signaling circuit may alternately include wireless communication links, incorporating Bluetooth or Near Field Communication (NFC) technology. Alternately, the signaling circuit may be formed as an optical link that includes LEDs, optical receivers, for example, photo transistors and optical fiber connected among the BMS. All such communication systems are well known and within the ordinary skill in the art.

The signaling circuit provides indication to all interconnected battery packs by way of a shared status line to communicate when one or more of the interconnected batteries are off line. The shared status line is monitored by the BMS by way of a monitor circuit in each battery pack to inform the battery packs of the status of all other battery packs. In a normal mode of operation, i.e. when all battery packs are on-line and their respective charge levels are synchronized, the shared status line is high. If an anomaly is detected in any one of the interconnected battery packs, i.e. one of the battery pack is off-line, the embedded BMS of the initiating off-line battery pack transitions the logic level of its Alert output, causing the signaling circuit to pull the shared status line low. The low shared status line is monitored by all interconnected battery packs causing them to be taken off-line by their respective BMS. Once the issue is resolved in the initiating battery pack, the BMS of the initiating battery pack releases its respective protection circuit to allow the battery pack to come back on-line and also resets its Alert output, which resets the signaling circuit and allows the shared status line to return to a normal low state. The monitoring circuits of the other interconnected battery packs will sense this transition of the shared status line and will signal their respective BMS to release their protection circuits and similarly allow their respective battery packs to come back online.

As used herein, the term “battery pack” is to be understood to include a device that includes one or more battery modules and a protection module in a common housing. Each battery module is to be understood to include one or more battery cells 28.

An exemplary battery protection module protection module is disclosed in U.S. Pat. No. 9,450,428, hereby incorporated by reference. Such battery protection modules are known to be included in battery packs to protect the battery modules from various abnormal conditions including: over-voltage, over-current and over-temperature by taking the battery modules off-line when an abnormal condition occurs and reconnecting the battery module when the abnormal problem is resolved.

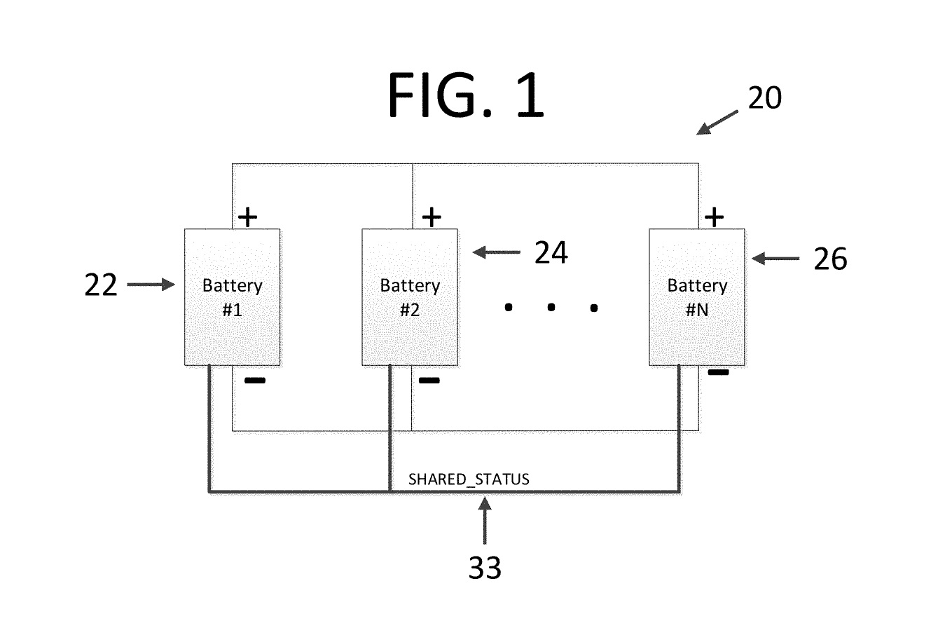

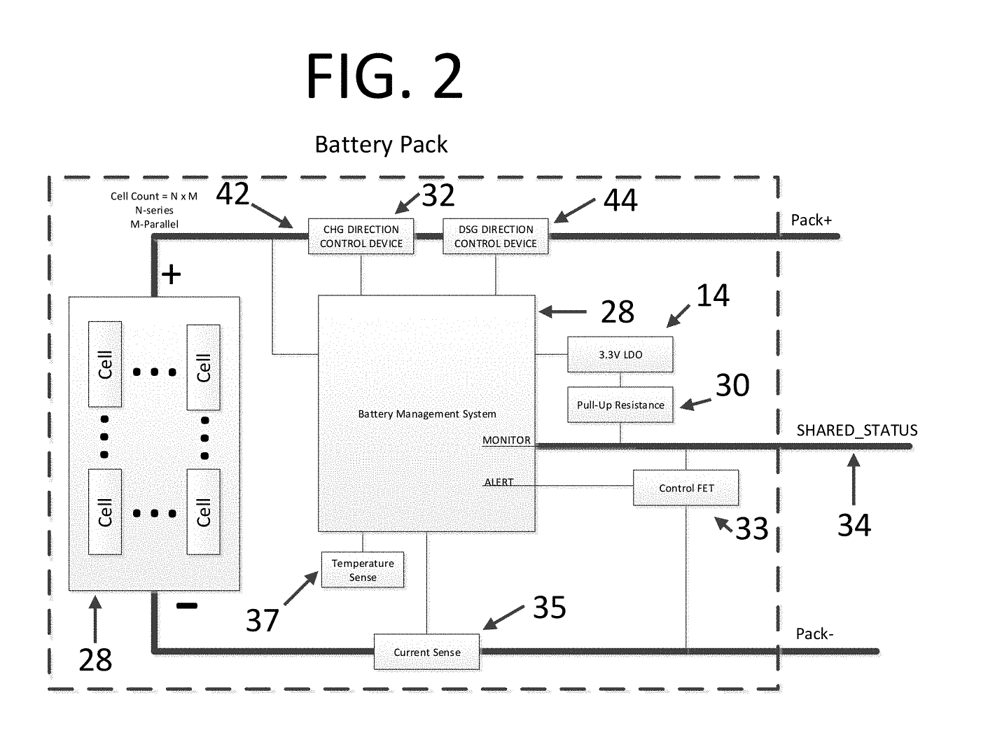

Referring to FIGS. 1 and 2, a system 20 is illustrated which includes a plurality of interconnected independent parallel packs 22, 24 and 26. Each battery pack 22, 24 and 26 is modular and includes one or more battery modules and an embedded battery management system module (BMS) 28. The BMS 28 has dual control functions. One function is to provide conventional over-current, over-voltage and over-temperature protection for the battery packs 22, 24 and 26, through control of contactors, relay contacts or FET transistors (“switches”) identified in FIG. 2 as a Charge (CHG) direction control device 42 and Discharge (DSG) direction control device 44. The other function is to provide charge-synchronization control of the battery packs 22, 24 and 26. In particular, the BMS 28 cooperates with the monitor circuit, protection circuit and signaling circuit to additionally provide charge control of the energy flow among the respective the battery packs 22, 24 and 26 to maintain a synchronized level of charge. Since the BMS 28 and its functions are virtually the same for all battery packs 22, 24 and 26, the system modular and able to be scaled to virtually “n” number of battery packs 26.

The embedded BMS 28 may be implemented as one or more integrated circuits, for example, Model No.bq40z50-R1, manufactured by Texas Instruments. The BMS 28 may be connected to a current sensor 35, a temperature sensor 37 and a voltage sensor (not shown) for providing over-current, over-temperature and over-voltage protection, respectively. The BMS 28 also controls the protection circuitry 42, 44 which automatically takes the battery packs 22, 24 and 26 off-line, i.e. interrupting energy flow when an anomaly occurs, and enabling the battery packs 22, 24 and 26 to be brought back on line when the anomaly is resolved.

The system and method disclosed herein is implemented with a monitoring circuit 30 for detecting anomalies in one or more battery packs 22, 24 and 26, a protection circuit 32 for controlling the energy flow from the battery packs 22, 24 and 26 and a signaling circuit 33 for alerting the battery packs 22, 24 and 26 when one or more battery packs 22, 24 and 26 are off-line.

The monitoring circuit 30 includes a pair of resistors R1 and R2, a pair of diodes D1 and D2, and a voltage reference, such as a 3.3V TTL reference 14. The protection circuit 32 includes a switch 42 and a switch 44. The signaling circuit 33 includes a shared status line 34 connected to all interconnected battery packs 22, 24 and 26, which it controls following an Alert signal output from the BMS 28. The signaling circuit also includes a transistor Q1 and a pair resistors R3 and R4. The shared status line 34 from the signaling circuit 33 is connected to an input port of the BMS 28 by means of the monitoring circuit 30 in each respective battery pack 22, 24 and 26. During normal conditions, the shared status line 34 is conditioned by the monitoring circuit 30 and pulled high, i.e. logical 1, by way of a voltage pull up resistor R1, a diode D1 and a pull-up voltage 14, for example, 3.3 volts DC. The logical “1” is applied to an input port on the BMS 28 by way of a resistor R2 and diode D2. During a normal condition, the diodes D1 and D2 are forward biased, thereby applying a logical “1” to the “monitor” input of the BMS 28. During this condition, the BMS 28 reads the logical “1” at its “monitor” input and assumes that no abnormal conditions exist, i.e. that all battery packs 22, 24 and 26 are on-line. An alert signal available at an output port of the BMS 28 is inactive during this condition.

The protection circuit 32 includes an over-current sensor 35, an over-temperature sensor 37 and an over-voltage sensor (not shown), connected to the BMS 28 and the switches 42 and 44. The switches 42, 44 are under the control of the BMS 28. When the BMS detects a safety condition and must terminate energy flow, or a battery pack 22, 24 or 26 is otherwise manually taken off line, the BMS 28 will control the switches 42,44 to disable energy flow and take the initiating battery pack off-line. When the safety condition is resolved, or the battery pack 22, 24 26 is brought on-line manually, the BMS 28 will signal the switches 42, 44 to bring the battery pack back online, thereby restoring the energy flow path.

The signaling circuit 33 includes a shared status line 34 that is connected to all interconnected battery packs 22, 24 and 26. The signaling signal 33 also includes a transistor Q1 and a pair resistors R3 and R4. The transistor Q1 may be, for example, an n-channel enhance mode field effect transistor (FET) Q1. The drain and source terminals of the FET are connected between the “shared status” line 34 and battery ground. Since the ground path is not interrupted by the protection circuits 42,44, the battery ground provides a stable reference for the open collector TTL output port of the BMS 28 for signal coherence. Alternatively in applications where the ground path is interrupted, the positive battery voltage rail may be used as a stable TTL signal reference. In such an application, the logic signals will be similarly inverted and an alternative control device, such as an p-channel enhance mode field effect transistor, may be used. The gate terminal of the transistor Q1 is connected to an output port of the BMS 28 defining an Alert signal. During normal conditions, the Alert signal is inactive and is low. The low Alert signal is applied to the gate of the transistor Q1 to maintain the transistor Q1 in an open position.

When any one of the battery packs 22, 24 and 26 is off-line, either automatically as a result of the protection circuitry or manually, the BMS 28 causes the Alert signal to become active to cause the transistor Q1 to close. When the transistor Q1 closes, the shared status line 34 of the initiating battery pack 22, 24 and 26 is connected to ground, thus resulting in its Monitor signal at the input port of its BMS 28 going low. Since all interconnected battery packs 22, 24 and 26 monitor the shared status line, all interconnected battery packs 22, 24 and 26 are alerted of the anomaly. As a result, their respective BMS 28 will cause their respective switches 42,44 (FIG. 2), connected in series with each of the interconnected battery packs 22, 24 and 26, to open automatically, thus taking those battery packs off-line and preventing further energy flow.

When the issue relating to the initiating battery pack 22, 24 and 26 is resolved, its BMS 28 will cause the Alert signal to go low which causes the transistor Q1 to open, thereby disconnecting the shared status line from ground. Once the shared status line is disconnected from ground, the Monitor signal will be pulled high by the pull-up voltage 14, resistors R1 and R2 and the diodes D1 and D2. The high Monitor signal at the BMS input port is applied to the monitor input port of all BMS 28 of the interconnected battery packs 22, 24 and 26 by way of the shared status line 34. The high Monitor signal causes all interconnected battery packs 22, 24 and 26 to be placed back on line by way of the switches 42,44.

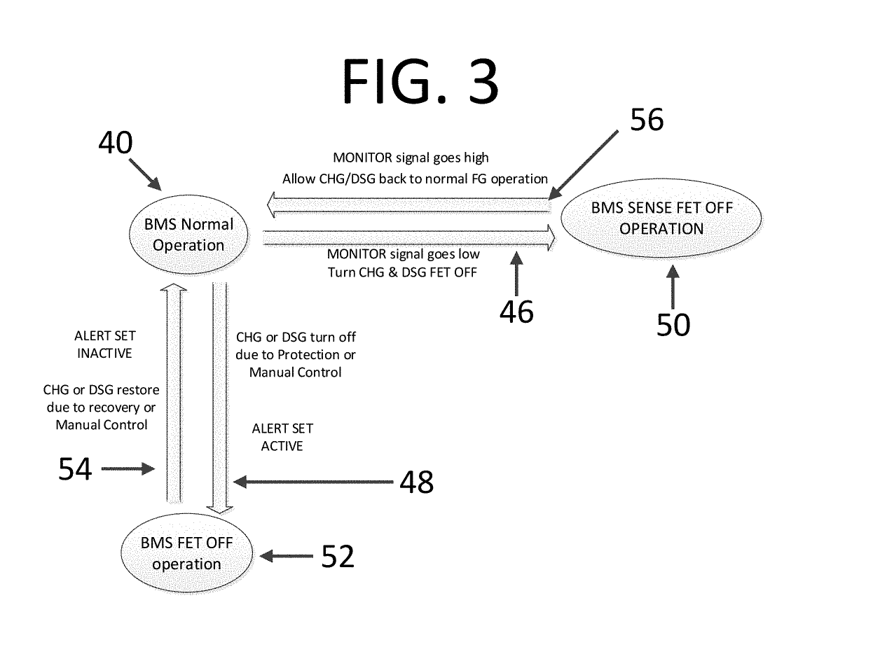

A state diagram of the system described above is illustrated in FIG. 3. In an initial state 40, all interconnected battery packs 22, 24 and 26 are operating normally with no abnormalities detected. In this state 40, the Monitor signal at the output of the respective BMSs 28 is high. Once an anomaly is detected in any one of the battery packs 22, 24 and 26 due to an abnormal condition, such as over-voltage, over-current or over-temperature or taken off line manually, the initiating BMS 28 will generate a trip signal to cause the protection circuit 32 to disconnect the battery pack 22, 24 and 26. The BMS 28 also generates an active Alert signal, as indicated by the arrow 48. The active Alert signal forces shared status line to go low, which, in turn, is communicated to all interconnected battery packs by the signaling circuit 33. Each respective BMS 28 senses the low Monitor signal by way its monitor circuit 30, thereby causing their respective BMS to generate trip signals to their protection circuits to cause the energy flow from the interconnected battery packs 22, 24 and 26 to be interrupted by the switches 42, 44 (FIG. 2), as indicated by the arrow 46. Once the anomaly in the initiating battery pack 22, 24 and 26 has been resolved or brought on line manually, the battery packs return to the normal state 40, as indicated by the arrow 54. In state 40, the initiating BMS will release the shared status line from GND by forcing the Alert signal low, thereby informing the interconnected batteries to resume energy flow and come back online. The non-initiating BMS will respond to the restoration of the shared status signal by re-enabling energy flow and coming back online, as indicated by the arrow 56 and also return to the normal state 40 in which all battery packs 22, 24, 26 are placed online.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A method for maintaining a synchronized state of charge of a plurality of parallel interconnected independent battery packs, each battery pack including one or more battery cells, an embedded battery management system, a monitoring circuit for monitoring anomalies in the one or more battery cells, a protection circuit for controlling the flow of energy in/out of the battery packs, a signaling circuit to alert the plurality of parallel interconnected batteries of the status of the battery packs, the method comprising the steps of:
(a) monitoring the status of each of said plurality of parallel interconnected independent battery packs;
(b) disabling the energy flow from said at least one battery pack in response to an anomaly by generating a trip signal that causes the protection circuit to disconnect the initiating battery pack;
(c) alerting the rest of said plurality of parallel interconnected independent battery packs that said trip signal has been generated in one of said battery packs; and
(d) disabling the energy flow from the rest of the interconnected battery packs that have been alerted in response to said trip signal.

2. A system for maintaining a synchronized state of charge of a plurality of interconnected independent battery packs, the system comprising:
an embedded battery management system (BMS) in a battery pack including a plurality of independent parallel connected battery modules;
a signaling circuit for providing an indication of an anomaly with one of the interconnected battery packs;
a monitoring circuit for monitoring the shared status line and providing an indication of the shared status line to the embedded BMS in each of the interconnected battery packs; and
a protection circuit for changing the logic state of the shared status line in response to a TTL signal from the embedded BMS.

3. The system as recited in claim 2, wherein said signaling circuit is configured as a single signal line connected to all of the interconnected battery packs.

4. The system as recited in claim 2, wherein said battery pack includes a battery protection module and sensors for providing over-current, over-voltage and over-temperature protection.

5. The system as recited in claim 2, wherein said signaling circuit is configured as a multiple signal lines connected to all of the interconnected battery packs.

6. The system as recited in claim 4, wherein said multiple signal lines are used to communicate specific types of the anomalies.

7. The system as recited in claim 2, wherein said signaling circuit includes a standard bus interconnected between all of the interconnected battery packs for communicating packetized information to said interconnected battery packs.

8. The system as recited in claim 7, wherein said signaling circuit is configured to communicate with other interconnected battery pack systems.

9. The system as recited in claim 2, where the TTL signal from the BMS is referenced to ground.

10. The system as recited in claim 2, where the TTL signal from the BMS is referenced to a positive rail of the battery.

11. The system as recited in claim 2, where the TTL signal from the BMS is referenced to an arbitrary voltage commonly established between the parallel connected batteries.

12. The system as recited in claim 2, wherein said signaling circuit is formed as a wireless links.

13. The system as recited in claim 2, wherein said signaling circuit is formed as optical links.
